(19) United States
(12) Patent Application Publication
(10) Pub. No.: US 2022/0064939 A1
(43) Pub. Date: Mar. 3, 2022

(54) TEMPERATURE STABLE VACUUM INSULATION ELEMENT

(71) Applicant: va-Q-tec AG, Würzburg (DE)

(72) Inventors: Roland Caps, Kleinwallstadt (DE); Sebastian Gralla, Würzburg (DE); Stefan Roth, Margetshöchheim (DE)

(21) Appl. No.: 17/446,119

(22) Filed: Aug. 26, 2021

(30) Foreign Application Priority Data
Aug. 27, 2020 (DE) 20 2020 104 960.7

(51) Int. Cl. E04B 1/80; F16L 59/065; F16L 59/02

(52) U.S. Cl. CPC E04B 1/803; F16L 59/028; F16L 59/065

(57) ABSTRACT

A temperature-stable vacuum insulation element 1 for use over a wide temperature range of high or low temperatures including a core material 2 of fumed silica in a proportion by weight in the range from 30% to 90%, a fiber material 3 in a proportion by weight in the range from 1% to 10%, an opacifier in a proportion by weight in the range from 5% to 50%; and a vacuum-tight envelope of the core material 2 of at least one stainless steel foil 4a, 4b.

### CROSS-REFERENCE TO RELATED APPLICATIONS

This patent application claims priority to German utility patent application number 20 2020 104 960.7 filed Aug. 27, 2020 and titled “temperature stable vacuum insulation element”. The subject matter of patent application number 20 2020 104 960.7 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND

Vacuum insulation elements are widely used, particularly in the form of vacuum insulation panels.

In conventional vacuum insulation panels, a pressure-stable core material, for example of fumed silica, is enveloped. A metallized plastic foil into which the core material is folded is usually used for enveloping. The envelope is evacuated, and the vacuum insulation panel exhibits excellent insulating properties compared to other insulation plate materials due to the vacuum generated therein. In particular, the reduced convection within the vacuum insulation panel due to evacuation contributes to the superior insulation properties.

Vacuum insulation panels of this kind are used in a wide variety of technical applications, for instance as insulating elements in transport containers or boxes for temperature-controlled transport or in the field of building materials, for example to insulate ceilings and walls when little space is available.

In this regard, there are drawbacks with regard to temperature stability, insofar as, for example, the properties of the plastic foil can change when used at particularly high temperatures. At higher temperatures, it can be observed that the tightness of the foil decreases, so that the vacuum present therein is no longer adequately maintained. When subjected to selective temperature loads, the plastic foil can also melt and be destroyed.

But even in the range of particularly low temperatures, it is difficult to produce vacuum insulation panels that can be used in practice over the long term with the structure described above.

It is known, for example, from WO 9 601 346 to provide a vacuum insulation panel with a stainless steel envelope. In this process, an upper part and a lower part of stainless steel are welded together to hermetically seal the intermediate space. Several layers of glass fiber mats are arranged in the core of this vacuum insulation panel.

A similar technique is disclosed in WO 2018 043 712, wherein a vacuum insulation panel is provided with a steel envelope. Here, too, the core material consists of a fiber material.

Furthermore, DE 10 2004 031 967 B4, DE 10 2010 005 800 A1 and DE 10 2013 218 689 A1 are known from the prior art.

The drawback with the solutions known in the prior art for a temperature-stable vacuum insulation element is that the production is costly and, in particular with respect to vacuum insulation.

### SUMMARY

The present invention relates to a temperature-stable vacuum insulation element according to claim 1.

It is the object of the present invention to eliminate the drawbacks from the prior art and to provide a temperature-stable vacuum insulation element for use over a wide temperature range of high or low temperatures. This object is achieved by a vacuum insulation element according to the independent claim. Advantageous aspects constitute the subject-matter of the respective subclaims.

The present invention encompasses a temperature-stable vacuum insulation element for use over a wide temperature range of high or low temperatures comprising:
a core material of fumed silica in a proportion by weight in the range from 30% to 90%;
a fiber material in a proportion by weight in the range from 1% to 10%;
an opacifier in a proportion by weight in the range from 5% to 50% by weight; and
a vacuum-tight envelope of the core material, as well as of the fiber material disposed thereon or therein and the opacifier, of at least one stainless steel foil.

Fumed silica is particularly suitable as a core material for vacuum insulation elements because it can be evacuated well in combination with a vacuum-tight envelope. A microporous structure of the fumed silica contributes to the good evacuability. By combining the core material of fumed silica and a vacuum-tight envelope of the core material of at least one stainless steel foil, a temperature-stable vacuum insulation element that can be used stably over a wide temperature range of high or low temperatures can be produced in a simple manner.

### BRIEF DESCRIPTION OF THE DRAWINGS

FIG. 1 shows a perspective view of a temperature-stable vacuum insulation element according to the invention.

### DETAILED DESCRIPTION

According to a particularly preferred aspect, the fiber material has a proportion by weight in the range from 2% to 5%.

It is also preferred if the fiber material comprises an opacifier having a proportion by weight in the range from 10% to 40%. The proportion by weight of the opacifier can be used to adjust the heat transfer by infrared radiation.

Advantageously, the fiber material is accommodated in the core material.

Preferably, the fiber material comprises glass fibers, such as quartz glass fibers, E-glass fibers or silicate fibers. Suitable E-glass fibers (electric-glass fibers) include, for example, aluminum borosilicate glass fibers.

Advantageously, the fibers of the fiber material have a thickness in the range from 2 μm to 25 μm and a length in the range from 2 mm to 30 mm.

It is particularly advantageous if the fiber material is binder-free. The binder-free fiber material enables advantageous arrangement of the fiber material in the core material of fumed silica while maintaining a microporous structure of the fumed silica. Furthermore, a binder-free fiber material allows the vacuum insulation element to be used over a wider temperature range.

Preferably, the core material, the fiber material, and the opacifier are formed in a binder-free compressed manner.

According to another preferred aspect, the opacifier comprises silicon carbide and/or graphite powder and/or carbon black and/or iron oxide and/or titanium oxide. By using opacifier, a reduction of heat transport by infrared radiation can be achieved.

Advantageously, the silicon carbide has a grain size in the range from 1 to 10 μm, in particular in the range from 3 μm to 5 μm.

According to a further preferred aspect, the vacuum insulation element is embodied such that the envelope comprises at least two stainless steel foils which are joined by welding. The stainless steel foils may be joined by resistance welding.

According to a particularly preferred aspect, the envelope comprises two stainless steel foils of different thicknesses. The use of two stainless steel foils of different thicknesses allows the envelope to be well shaped.

Advantageously, the thinner stainless steel foil has a recess for the core. The thicker foil is designed as a planar surface.

It is particularly advantageous here if one stainless steel foil has a thickness in the range from 10 μm to 100 μm, in particular in the range from 20 μm to 75 μm, and the other stainless steel foil has a thickness in the range from 50 μm to 300 μm, in particular 75 μm to 150 μm.

Advantageously, the stainless steel foils are designed so as to be smooth or embossed (on the surface).

It is technically particularly preferred if, furthermore, a finely porous, temperature-stable non-woven filter web is arranged between the envelope and the core material

In the following, the invention will be explained in more detail below with reference to drawings. Identical reference signs describe identical features, wherein.

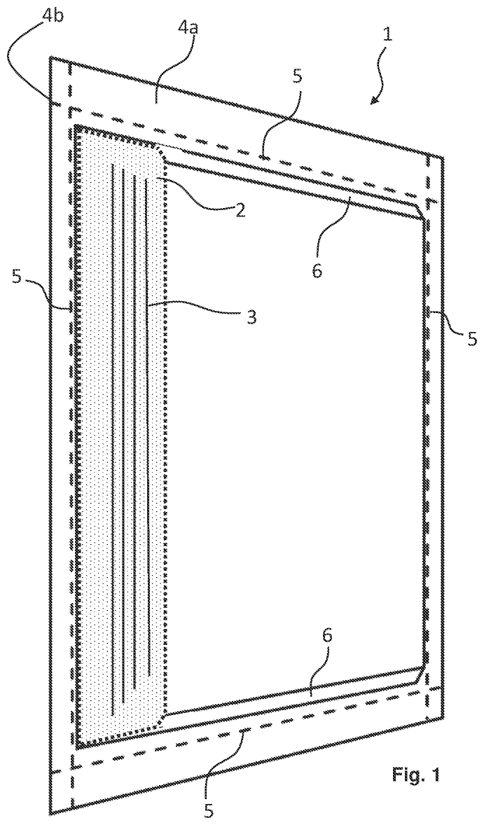

FIG. 1 shows a perspective view of a temperature-stable vacuum insulation element 1 according to the invention.

The temperature-stable vacuum insulation element 1 is suitable for use over a wide temperature range of high or low temperatures. In particular, it can be used over a temperature range of 0.1 K to 873 K. The vacuum insulation element 1 comprises a core material 2 of fumed silica in a proportion by weight of 90%.

The fumed silica forms a microporous structure. On the one hand, this ensures the stability of the structure. Furthermore, in combination with a vacuum-tight envelope, the fumed silica is particularly suitable as core material 2 for vacuum insulation elements 1, since it creates a system that can be evacuated well.

The vacuum insulation element 1 further comprises a fiber material 3 in a proportion by weight of 5% and an opacifier in a proportion by weight in the range of 5%. By using opacifier, such as silicon carbide, reduction of heat transport by infrared radiation can be achieved.

The fiber material 3 shown in this example is binder-free and comprises glass fibers. The binder-free fiber material 3 enables advantageous arrangement of the fiber material 3 in the core material 2 of fumed silica while maintaining a microporous structure of the fumed silica. Furthermore, a binder-free fiber material 3 allows the vacuum insulation element 1 to be used over a wider temperature range.

The vacuum-tight envelope of the core material 2 consists of two stainless steel foils 4a, 4b which are joined by resistance welding at the welds 5. In particular, the combination of fumed silica as core material 2 and a vacuum-tight envelope of the core material 2 of two stainless steel foils 4a, 4b makes it possible to provide a temperature-stable vacuum insulation element 1 for use over a wide temperature range of high or low temperatures.

The two stainless steel foils 4a, 4b shown in this example, which are designed so as to be smooth on the surface, have different thicknesses to ensure good shaping of the envelope. For example, the stainless steel foil 4a has a thickness of 50 μm, and the other stainless steel foil 4b has a thickness of 150 μm. For example, for shaping the vacuum insulation element 1 shown, one of the two stainless steel foils 4a has been deep-drawn to have ridges 6 which are inclined at an angle of 20°.

What is claimed is:

1. Temperature-stable vacuum insulation element for use over a wide temperature range of high or low temperatures comprising:
a core material of fumed silica in a proportion by weight in the range from 30% to 90%;
a fiber material in a proportion by weight in the range from 1% to 10%;
an opacifier in a proportion by weight in the range from 5% to 50%; and
a vacuum-tight envelope of the core material of at least one stainless steel foil.

2. Vacuum insulation element according to claim 1, wherein the fiber material has a proportion by weight in the range from 2% to 5%.

3. Vacuum insulation element according to claim 1, wherein the opacifier has a proportion by weight in the range from 10% to 40%.

4. Vacuum insulation element according to claim 1, wherein the fiber material is accommodated in the core material.

5. Vacuum insulation element according to claim 1, wherein the fiber material comprises glass fibers, quartz glass fibers, E-glass fibers or silicate fibers, in particular having a thickness in the range from 2 μm to 25 μm and a length in the range from 2 mm to 30 mm.

6. Vacuum insulation element according to claim 1, wherein the core material, the fiber material and the opacifier are formed in a binder-free compressed manner.

7. Vacuum insulation element according to claim 1, wherein the opacifier comprises silicon carbide and/or graphite powder and/or carbon black and/or iron oxide and/or titanium oxide.

8. Vacuum insulation element according to claim 7, wherein the silicon carbide has a grain size in the range from 1 to 10 μm, in particular in the range from 3 μm to 5 μm.

9. Vacuum insulation element according to claim 1, wherein the envelope comprises at least two stainless steel foils which are joined by welding.

10. Vacuum insulation element according to claim 1, wherein the envelope comprises two stainless steel foils of different thicknesses.

11. Vacuum insulation element according to claim 10, wherein the thinner stainless steel foil comprises a recess for the core, and wherein the thicker foil is designed as a planar surface.

12. Vacuum insulation element according to claim 10, wherein one stainless steel foil has a thickness in the range from 10 μm to 100 μm, in particular in the range from 20 μm to 75 μm, and wherein the other stainless steel foil has a thickness in the range from 50 μm to 300 μm, in particular 75 μm to 150 μm.

13. Vacuum insulation element according to claim 1, wherein the stainless steel foils are designed so as to be smooth or embossed.

14. Vacuum insulation element according to claim 1, further comprising a finely porous, temperature-stable non-woven filter web arranged between the envelope and the core material.
